(19) United States
(12) Patent Application Publication
(10) Pub. No.: US 2018/0017037 A1
(43) Pub. Date: Jan. 18, 2018

(54) Hub and Rotor Assemby for Wind Turbines with Conjoined Turbine Blades

(71) Applicant: James L. Kissel, Rapid City, SD (US)

(72) Inventor: James L. Kissel, Rapid City, SD (US)

(21) Appl. No.: 15/210,347

(22) Filed: Jul. 14, 2016

(51) Int. Cl. F03D 1/06

(52) U.S. Cl. CPC F03D 1/0675; F03D 1/0691; F05B 2240/221; F05B 2220/30; F05B 2240/30; F05B 2220/706

(57) ABSTRACT

A hub and rotor assembly for wind turbines which include one or more conjoined blades. Each conjoined blade comprises two separate blade sections that are affixed together by a plurality of dividers or spacers. Each divider/spacer attaches to the inferior face of the first blade and the superior face of the second blade. This construction of rotor blades allows the wind to flow over and between the blades, by virtue of the space created between the two blade sections and thereby increases the surface area affected by or pushed by the wind and reduces the structural weight of each blade as compared to the prior art. Each blade is further contoured or curved to provide an area upon which the wind can “push” each blade as the wind passes over and between the blade sections which make up each conjoined blade.

### TECHNICAL FIELD

This invention relates to designs for wind turbines.

### BACKGROUND OF THE INVENTION

Wind Power is considered one of the cleanest, most environmentally friendly energy sources presently available, and wind turbines have gained increased attention in this regard. A modern wind turbine typically includes a tower, a generator, a gearbox, a nacelle and one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

There is a general desire for wind turbine rotors to produce as much energy as possible for a given wind speed. Most modern wind turbines seek an increased power production by means of larger rotor sizes. This resulted in the need for dedicated wind farms for large wind turbines. The weight of the blades directly affects the inertia of the rotor and the loads at the shaft.

The particular size of wind turbine rotor blades is a significant factor contributing to the overall efficiency of the wind turbine. Specifically, increases in the length or span of a rotor blade may generally lead to an overall increase in the energy production of a wind turbine. However, as rotor blade sizes increase, so do the loads transferred through the blades to other components of the wind turbine (e.g., the wind turbine hub and other components). For example, longer rotor blades result in higher loads due to the increased mass of the blades as well as the increased aerodynamic loads acting along the span of the blade. Such increased loads can be particularly problematic in high-speed wind conditions, as the loads transferred through the rotor blades may exceed the load bearing capabilities of other wind turbine components.

It is an object of the embodiments of this invention to provide improvements to the configuration of wind turbines and wind turbine blades to increase power output. Embodiments of the invention are notably concerned with increasing lift on the blades. More specifically, it is an object of the embodiments of the invention to increase the surface area of the blades upon which the wind acts upon to increase the amount of force exerted upon the blades and thereby increase energy captured from the wind. This will yield an efficient wind turbine with very low manufacturing and operating costs.

The use of the conjoined blades as described herein has two major benefits over the prior art. First, the use of the conjoined blades dramatically increases the strength and durability of each blade over the prior art. This increased strength and durability allows the Conjoined Blades to be manufactured to nearly any desired length. Second, the use of Conjoined Blades increases the ability of the wind turbine to capture energy from the wind over that of the prior art. By using Conjoined Blades, the surface area on which the wind acts upon the blades is effectively doubled, while significantly reducing the blade mass over state of-the-art designs. The conjoined blades further address the challenges for wind turbines by reducing the turbine's structural weight. The reduced weight of the blades helps ease the concerns noted above since both the inertial and dynamic loads are reduced.

The prior art indicates that increasing the number of blades beyond the industry standard of three would yield no added benefit to the amount of energy that can be captured by a wind-turbine. However, with the present conjoined blade design, the addition of three more blades yielded a significant increase in the amount of capturable energy. Through engineer testing, it is found that the present embodiment of the invention is capable of harnessing and collecting up to 290 percent as much energy before stalling as the normally accepted industry standard wind turbine under the same conditions.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a slightly offset front view of the Hub 110 and Conjoined Blades 118 Assembly. In this Figure, only two of the Conjoined Blades 118 are depicted, yet the remaining would be present when the invention is operated or constructed.

FIG. 2 is an outer view of the conjoined blade focusing upon the connection between the superior and inferior blades and the Divider-Spacers that affix to both.

FIG. 3 shows the curvature or contour of each blade section of the Conjoined Blades as it relates to wind direction once mounted upon the Hub.

### REFERENCE NUMERALS

Hub 110
First Rotor Blade 112
Second Rotor Blade 114
Divider-Spacer 116
Conjoined Blade 118
Wind Direction 120
Rotor Axis 122
Leading Edge 210
Trailing Edge 212

### DETAILED DESCRIPTION OF INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The invention is directed at a Hub or Rotor Assembly for horizontal axis Wind Turbines with a rotor which includes a Hub 110 having at least one rotor blade affixed to and extending radially outward from the Hub 110. The Rotor or Hub 110 assembly is rotatable around a Rotor Axis. At least one of the rotor blades, and preferably each of the rotor blades, of the present rotor or hub assembly is a Conjoined Blade 118 as described below.

The term ‘Rotor Axis’ should be understood as the axis of the rotor, i.e. that axis around which the rotor and hub assembly rotates during power-producing operation of the wind turbine. The Rotor Axis 122 is normally aligned orthogonally to the wind direction 120. Through the Rotor or Hub 110 assembly rotating about the Rotor Axis 122, the driving torque produced by the rotation of the rotor blades is transmitted to the main shaft of the Wind Turbine as is well defined in the prior art.

The Rotor and Hub Assembly, having a Hub 110, from which the Conjoined Blades 118 extend substantially in a radial direction when mounted to the Hub 110. The Hub 110 has an upwind portion and downwind portion. The upwind portion is upwind of the downwind portion relative to the wind direction 120. The Hub 110 in the present invention is hexagonal in shape as to provide area for connection of each Conjoined Blade 118 but may be any shape that allows for secure connection of the Conjoined Blades 118. The Hub 110 further comprises a means for attachment to an electrical generator within a nacelle of a Wind Turbine or connected directly to the main shaft of a Wind Turbine for the production of electrical energy, as is common in the prior art.

Each Conjoined Blade 118 having a longitudinal direction with a proximal end and a distal end and a transverse direction as well as a leading edge 210 and a trailing edge 212. The leading edge 210 is upwind of the trailing edge 212 relative to the wind direction 120. When the rotor blades are impacted by an incident airflow, lift is generated causing the Hub 110 and rotor blades to rotate about the Rotor Axis 122.

Each Conjoined Blade 118 may be spaced about the Hub 110 to facilitate rotating the Hub 110 and Conjoined Blades 118 about the Rotor Axis 122 to enable kinetic energy to be transferred from the wind into usable mechanical energy, and subsequently, electrical energy. For example, the Rotor or Hub Assembly may be rotatably coupled to an electrical generator within a nacelle of a Wind Turbine or connected directly to the main shaft of a Wind Turbine for the production of electrical energy. The described rotor and hub assembly may be incorporated into or included in virtually any already existing wind turbine.

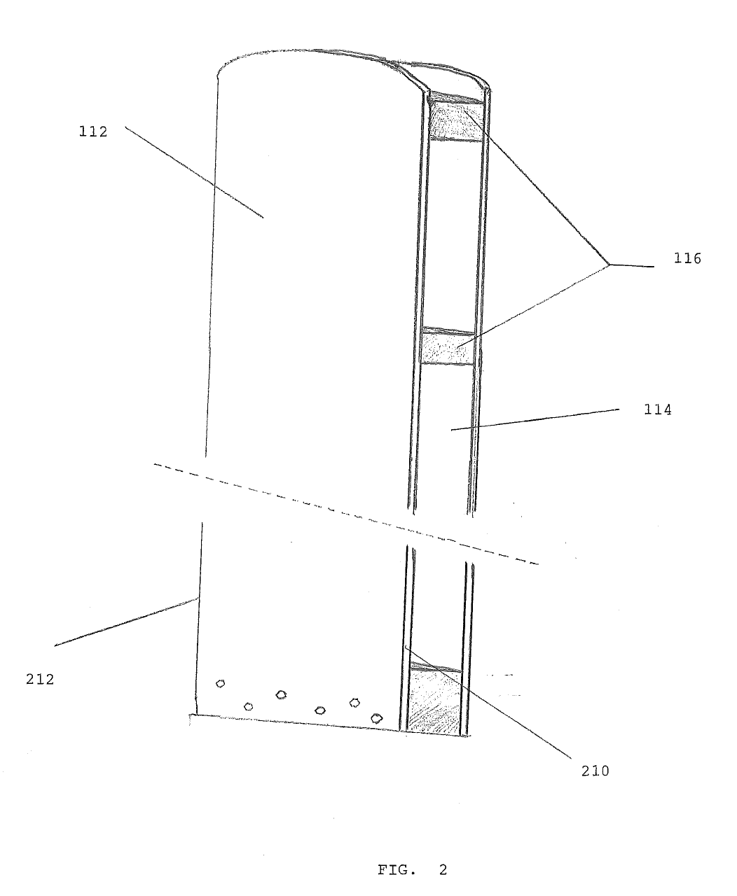

Each Conjoined Blade 118 comprises two independent blade sections that are connected to and affixed together by one or more Divider-Spacers 116 as shown on FIG. 2 and FIG. 4. The inferior face of the first blade section affixes to the superior face of a Divider-Spacer 116. The Superior face of the second blade affixes to the inferior face of the Divider Spacer 116. The Divider Spacers 116 are affixed and placed at the proximal end, at or near the distal end, and equidistantly in between at intervals along the length of the blades approximately ten to eighteen feet apart. For example, a fifty (50) foot blade would likely have four Divider-Spacers 116: one at the proximal end, one at the distal end, and two equidistantly placed Divider-Spacers 116 along the length of the blades. Each Conjoined Blade 118 is affixed at its proximal end radially about the Rotor. It is anticipated that the Divider-Spacer 116 located at the proximal end of each Conjoined Blade 118 will have a greater width, even twice as wide, so as to allow for greater support and to provide area for attachment of the Conjoined Blade 118 to the Hub 110.

The Conjoined Blades 118 are constructed so as to allow air flow to pass over between the first blade 112 and the second blade 114. In the present embodiment of the invention, the Divider-Spacers 116 have a height so as to create a space between the First Blade 112 and Second Blade 114 whereby the wind may pass over not only the First Blade 112 but also over the Second Blade 114, through the space created between the First Blade 112 and the Second Blade 114 by virtue of the height of the Divider-Spacers 116. This allows each Conjoined Blade 118 to be affected by greater lift when acted upon by an incident airflow.

In the present embodiment of the invention, each Divider Spacer 116 has a uniform height so that the First Blade 112 and the Second Blade 114 are parallel to one another. The Divider-Spacers 116 are normally constructed so that they have the same transverse width as the First Blade 112 and the Second Blade 114 so that they are flush with the Leading Edge 210 and Trailing Edge 212 of each blade section. However, the Divider-Spacers 116 may be constructed so that they are not flush, so long as the Divider-Spacers 116 conjoin the First Blade 112 and the Second Blade 114 as shown in FIG. 2 and create a space between the two blade sections through which wind may flow.

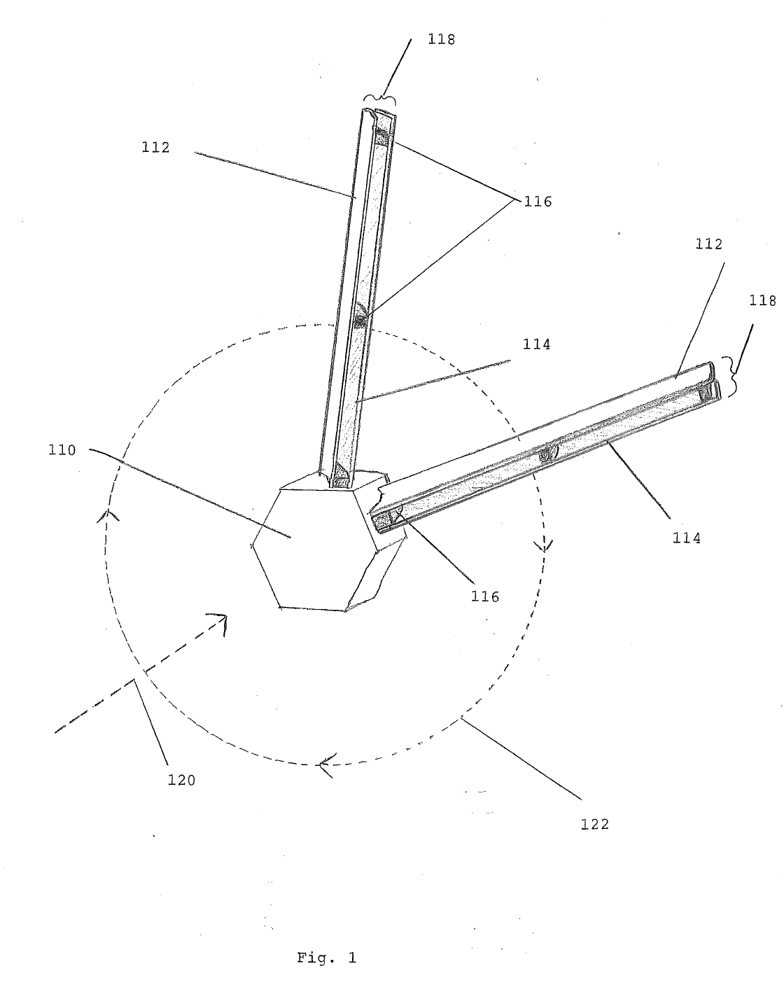

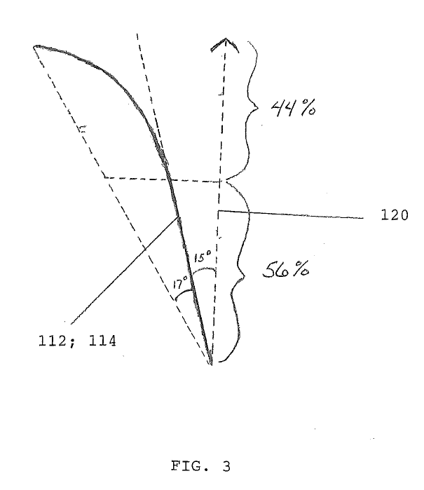

Both the first blade 112 and the second blade 114 are curved along their width as can be seen in FIG. 1. Each blade is designed to be curved in a manner to catch the wind as it passes along its surface. In the present embodiment, the first 56% of the width of each blade from the leading edge of the blade is straight or flat, having no curvature. In the present embodiment of the invention, each blade is positioned on the Hub so that the flat upwind portion of the width of the blade is angled 15 degrees off from the direction of the wind. The remaining 44% of the width of each blade is curved to the extent that the entire blade is set at an angle of 32 degrees from the wind direction at the downwind edge of the blade as shown in FIG. 1. This design allows the wind to “push” the first blade 112 and the second blade 114 as the wind passes past and between the First Blade 112 and Second Blade 114 of the Conjoined Blades 118. These angles are designed so as to allow the wind to push against the curved portion of the blade increasing the force applied by the wind to the Conjoined Blade 118 and thereby increasing the energy captured from the wind. Each Divider-Spacer 116 conforms to the same curvature as described above and is formed to mate with the inferior face of the first blade 112 and the superior face of the second blade 114 as shown in FIG. 3.

In the present embodiment of the invention, six Conjoined Blades 118 are affixed radially about the Hub 110 at equidistant points. These Conjoined Blades 118 rotate about the Rotor Axis 122. The Hub 110 interconnects the blades of the wind turbine to the horizontal main shaft or generator of a wind turbine. The hub 110 transmits the driving torque to the horizontal main shaft or generator of a wind turbine. Although the present embodiment includes six rotor blades, in an alternative embodiment, the Rotor and Hub Assembly may include more or less than six rotor blades.

Each Conjoined Blade 118 should be balanced with each other Conjoined Blade 118 so that there are no blades heavier than others. The balancing of the Conjoined Blades 118 should be performed so as no blades will, by virtue of their weight, rest at the lowest portion of the Rotor Axis 122. The balancing of the Conjoined Blades 118 ensures that the amount of energy or force needed to begin the rotation of the rotor 114 about the Rotor Axis 122 is not increased by the added power needed to shift the heavier Conjoined Blades 118 from their resting position to begin the power-producing operation of the wind turbine.

The current embodiment of the invention uses either 20 or 26 gauge galvanized steel as the thin metal reduces the structural weight of the Conjoined Blades 118 and aids in reducing turbulence which can damage components of a wind turbine. However, other rigid material may also be suitable. It should be understood that the Hub 110 may be fabricated from any suitable material including, but not limited to, galvanized steel, glass composites, carbon composites, or carbon fiber.

While the above description contains many specificities, these should not be construed as limitations on the scope, but rather as an exemplification of one embodiment thereof. Many other variations are possible. Further modification and adaptation to these embodiments will be apparent to those skilled in the art and may be implemented without departing from the scope or spirit of the invention. Accordingly, the scope should be determined not by the embodiment illustrated, but by the appended claims and their legal equivalents.

I claim:

1. A hub or rotor assembly for a horizontal axis wind turbine in relation to a wind direction, said hub or rotor assembly comprising:
(a) A hub having an upwind portion and a downwind portion, the upwind portion being upwind from the downwind portion relative to the wind direction, said hub further defining an axis of rotation; and
(b) A plurality of rotor blades extending essentially radially about said hub wherein at least one of said rotor blades comprise:
i) a first blade
ii) a second blade
iii) a plurality of dividers/spacers
wherein open spaces between said first blade and said second blade are created which are defined by said first blade, said second blade and said divider/spacers through which wind may flow.

2. The invention described in claim 1 wherein said plurality of rotor blades are equally spaced radially about said hub.

3. The invention described in claim 1 wherein said first blade and said second blade are contoured or curved to provide an uplifted surface area for the wind to push against as it flows over the surface of said rotor blades.

4. The invention described in claim 3 wherein said plurality of rotor blades are contoured or curved as described herein.

5. The invention described in claim 3 wherein said divider/spacers are shaped to mate with the inferior face of said first blade and the superior face of said second blade.

6. The invention described in claim 1 wherein said plurality of dividers/spacers are affixed to the inferior face of said first blade and the superior face of said second blade.

7. The invention described in claim 6 wherein said dividers/spacers are affixed at the proximal ends of said first blade and said second blade, at or near the distal ends of said first blade and said second blade, and at intervals between said dividers/spacers.

8. The invention as described in claim 7 wherein said intervals are equidistant.

9. The invention described in claim 7 wherein said intervals are between ten to eighteen feet.

10. The invention described in claim 4 wherein each of said rotor blades are affixed radially about said hub and positioned so that said rotor blades are angled off from said wind direction as described herein.

11. A rotor blade for a wind turbine comprising:
i) a first blade
ii) a second blade
iii) a plurality of dividers/spacers
wherein open spaces between said first blade and said second blade are created which are defined by said first blade, said second blade and said divider/spacers through which wind may flow.

12. The invention described in claim 11 wherein said first blade and said second blade are contoured or curved to provide an uplifted surface area for the wind to push against as it flows over the surface of said rotor blades.

13. The invention described in claim 12 wherein said plurality of rotor blades are contoured or curved as described herein.

14. The invention described in claim 12 wherein said divider/spacers are shaped to mate with the inferior face of said first blade and the superior face of said second blade.

15. The invention described in claim 11 wherein said plurality of dividers/spacers are affixed to the inferior face of said first blade and the superior face of said second blade.

16. The invention described in claim 15 wherein said dividers/spacers are affixed at the proximal ends of said first blade and said second blade, at or near the distal ends of said first blade and said second blade, and at intervals between said dividers/spacers.

17. The invention as described in claim 15 wherein said intervals are equidistant.

18. The invention described in claim 15 wherein said intervals are between ten to eighteen feet.
